(19) United States
(12) Patent Application Publication
(10) Pub. No.: US 2024/0146105 A1
(43) Pub. Date: May 2, 2024

(54) Wireless Electric Cord

(71) Applicant: Tracy Burnside, Laurens, SC (US)

(72) Inventor: Tracy Burnside, Laurens, SC (US)

(21) Appl. No.: 17/976,018

(22) Filed: Oct. 28, 2022

(51) Int. Cl. H02J 50/10; H02J 50/00; H02J 50/80

(52) U.S. Cl. CPC H02J 50/10; H02J 50/005; H02J 50/80; H04B 5/0037

(57) ABSTRACT

The wireless power cord is the only product of its kind that has the capability a powering a wall mounted television without showcasing wires; thereby, eliminating the unappealing sight of many wires trailing down a wall. This unprecedented device is uniquely designed for wall mounted TV's and is carefully crafted with durable materials that work in complement with advanced technology to ensure complete functionality and sustainability while offering a discrete solution to a common problem and can be easily installed and set-up for private or commercial utilization.

### BACKGROUND

Wall mounted televisions tend to have individuals managing the placement of multiple cords which can either become a tripping hazard or aesthetically unpleasing. Given the sheer volume of wires that dwell in a modern home, figuring out how to hide these TV wires, cords and cables can be incredibly frustrating. There have been no products available as original equipment or as an aftermarket to address this problem.

An apparatus to limit the amount of wires necessary for your TV to function, is not being met by any known device or system at present. There have been no products available as original equipment or as an aftermarket to address this problem either.

### SUMMARY OF THE INVENTION

The main purpose of the wireless electric cord is to provide users with a charging medium that discreetly powers a TV without the eye sore of exposed wires.

An inductive electrical coupling device includes a receiving coil, a receiver board coupled to the receiving coil and having variable input voltages with respect to ground, a case for the receiving coil, a transmitting coil; a transmitter board coupled to the transmitting coil and having variable output voltages with respect to ground, a case for the transmitting coil, a battery configured to store an electrical charge transferred from the transmitting coil to the receiving coil, and a memory configured to store an electrical data and instruction transferred from the transmitting coil to the receiving coil.

### BRIEF DESCRIPTION OF THE DRAWINGS

FIG. 1 is a pictorial inside view of the wireless electric cord receiver in accordance with an embodiment of the present disclosure.

FIG. 2 is a top outside view of the wireless electric cord receiver in accordance with an embodiment of the present disclosure.

FIG. 3 is a pictorial inside view of the wireless electric cord transmitter in accordance with an embodiment of the present disclosure.

FIG. 4 is a top outside view of the wireless electric cord transmitter in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

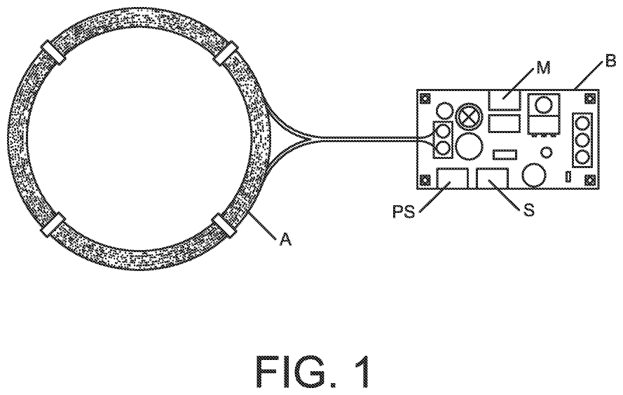

FIG. 1 is a pictorial inside view of the wireless electric cord receiver showing: receiving coil referenced as A, receiver board output voltage 2V to 12V 5V GND referenced as B, detachable electric cord referenced as I, in accordance with an embodiment of the present disclosure. The wireless electric cord is implemented for signals, control, data and power through electricity. A battery PS and memory M are included for storing a respective transferred charge and data and instruction from the transmitter to the receiver and supplying that stored charge to an electronic device in a quiescent transfer state. Also a sensor S includes an ability to turn on and off the wireless electric cord based on infrared detection of a person or an animal in the shared space/room and based on a light detection for night time transfers and charging and storing data and instructions/control.

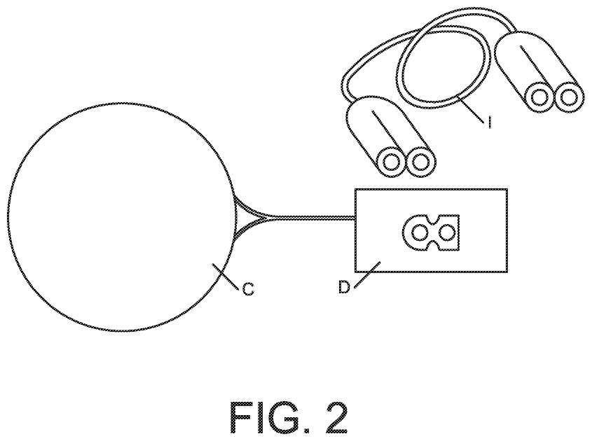

FIG. 2 is a top outside view of the wireless electric cord receiver showing: receiving coil plastic hard case that sticks on TV referenced as C, plastic hard case with TV outlet referenced as D, in accordance with an embodiment of the present disclosure. The case can be hard plastic or a round throw rug, or a lamp base or a ceiling and baseboard molding and even a standard AC wall socket accessory for a repeater to conceal and disguise the transmitter and the receiver.

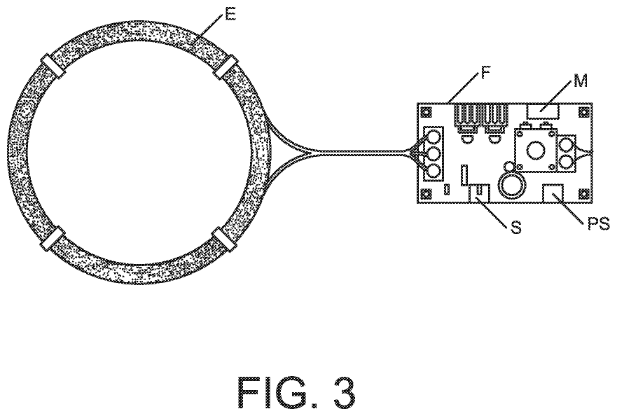

FIG. 3 is a pictorial inside view of the wireless electric cord transmitter showing: transmitting coil referenced as E, transmitter board input voltage 6V AC-DC 2-Amp referenced as F, in accordance with an embodiment of the present disclosure, A battery PS and memory M are included for storing a respective transferred charge and data and instruction from the transmitter to the receiver and supplying that stored charge to an electronic device in a quiescent transfer state. Also a sensor S includes an ability to turn on and off the wireless electric cord based on infrared detection of a person or an animal in the shared space/room and based on a light detection for night time transfers and charging and storing data and instructions/control.

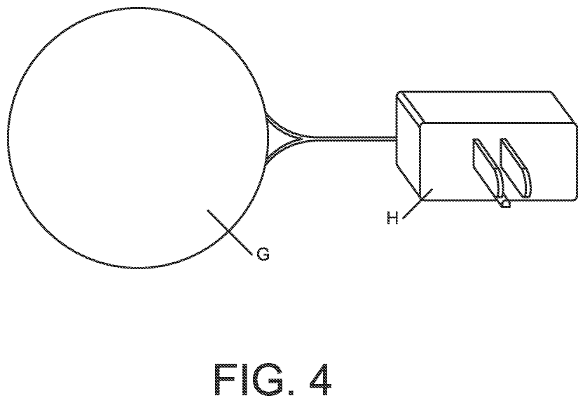

FIG. 4 is a top outside view of the wireless electric cord transmitter showing: transmitting coil plastic hard case that sticks where desired referenced as G, plastic hard case with electric outlet referenced as H, in accordance with an embodiment of the present disclosure. This implementation is amenable to being used as a repeater of the transmitted electricity received at a distant receiver since it includes a standard AC alternating current wall plug. Direct current DC models are also disclosed herein. The case can be hard plastic or a round throw rug, or a lamp base or a ceiling and baseboard molding and even a standard AC wall socket accessory for a repeater to conceal and disguise the transmitter and the receiver.

Ingenious and practical, the wireless power cord offers a modern accessory that keeps things looking neat and removes any potential hoards for little ones and/or pets by eliminating the need to use long extended wires to power televisions. The wireless power cord introduces a novel two part device that powers a TV whereas the first part of the device plugs into the back of the TV and the second part plugs into a primary outlet. With advanced technology, the two components correspond with each other and power the TV without the need of using any wires and/or formal attachments. This innovative, top-quality product keeps the cords of a wall-mounted TV out of sight and makes a world of difference in interior design as it keeps décor looking sleek and tidy.

Although the operations of the methods) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. An electrical coupling device comprising:
a receiving coil;
a receiver board coupled to the receiving coil and comprising variable input voltages with respect to ground;
a case for the receiving coil;
a transmitting coil;
a transmitter board coupled to the transmitting coil and comprising variable output voltages with respect to ground;
a case for the transmitting coil;
a battery configured to store an electrical charge transferred from the transmitting coil to the receiving coil; and
a memory configured to store an electrical data and instruction transferred from the transmitting coil to the receiving coil.

2. The electrical coupling device of claim 1, wherein the electrical case is a round floor rug.

3. The electrical coupling device of claim 1, wherein the electrical case is a round crown molding adjacent a wall and a ceiling.

4. The electrical coupling device of claim 1, wherein the electrical case is a ceiling lamp enclosure.

5. The electrical coupling device of claim 1, wherein the electrical case is a baseboard molding adjacent a wall and a floor.

6. The electrical coupling device of claim 1, wherein the case is a wall socket accessory.

7. The electrical coupling device of claim 1, wherein the case is a hard plastic encasement that sticks onto a television.

8. The electrical coupling device of claim 1, wherein the case is a hard plastic encasement that sticks onto an electronic device including an amplifier, a hard drive and speaker.

9. The electrical coupling device of claim 1, further comprising an infrared sensor configured to turn on and off coupling based on detection of a person or pet in a shared space.

10. The electrical coupling device of claim 1, further comprising a light sensor configured to turn on and off coupling based on detection of light in a shared space.

11. The electrical coupling device of claim 1, further comprising a repeater transmitter configured to power from a wall socket coupling and extend an inductive coupling range of the transmitter.

12. The electrical coupling device of claim 1, wherein the variable input voltages of the receiver comprise direct current and alternating current 2V, 5V and 12V relative to ground at variable amperages for respective transformers.

13. The electrical coupling device of claim 1, wherein the variable output voltages of the transmitter comprise direct current and alternating current 2V, 5V and 12V relative to ground at variable amperages for respective transformers.

14. The electrical coupling device of claim 1, further comprising a detachable power cord extending from the transceiver to a standard AC outlet.

15. The electrical coupling device of claim 1, further comprising a detachable power cord extending from the receiver to a standard AC outlet.

16. The electrical coupling device of claim 1, wherein the battery is configured to deliver the stored charge to an electronic device based on a quiescent electrical Charge transfer from the transmitting coil to the receiving coil.

17. The electrical coupling device of claim 1, wherein the memory is configured to deliver the stored data and instruction to an electronic device based on a quiescent electrical transfer from the transmitting coil to the receiving coil.
